(19) United States
(12) Patent Application Publication
(10) Pub. No.: US 2012/0158476 A1
(43) Pub. Date: Jun. 21, 2012

(54) Social Marketing Manager

(75) Inventors: John NEYSTADT, Kfar-Saba (IL); Ron KARIDI, Herzeliya (IL); Yitzhak Tzahi WEISFELD, Hod Hasharon (IL); Roy VARSHAVSKY, Even Yehuda (IL); Avigad ORON, Tel Aviv (IL); Kira RADINSKY, Zichron Yaakov (IL); Moshe Tennenholtz, Haifa (IL)

(73) Assignee: MICROSOFT CORPORATION, Redmond, WA (US)

(21) Appl. No.: 13/025,049

(22) Filed: Feb. 10, 2011

Related U.S. Application Data
(63) Continuation-in-part of application No. 12/970,968, filed on Dec. 17, 2010.

(51) Int. Cl. G06Q 30/00

(52) U.S. Cl. 705/14.16

(57) ABSTRACT

A social marketing manager may facilitate marketing campaigns in online social networks by creating and monitoring campaigns, as well as facilitating online social interactions. A campaign manager may create a campaign and define various operational parameters. A recruitment system may identify social influencers through which the campaign may be started, and a promotion manager may create and track objects that may be passed to participants in the campaign. An analysis and monitoring system may determine the overall effectiveness of the campaign and provide feedback, payments to participants, or other results of the campaign.

### CROSS REFERENCE TO RELATED APPLICATIONS

This patent application is a continuation-in-part of and claims priority to and benefit of U.S. patent application Ser. No. 12/970,968 entitled “Social Incentives Platform” by Moshe Tennenholtz, et al., filed 17 Dec. 2010, the contents of which are hereby expressly incorporated by reference for all they teach and disclose.

### BACKGROUND

Computer users today are members of a variety of social networks through which they are connected with a great many users. Computer users may have personal networks through websites such as Facebook and MySpace, professional networks through websites such as LinkedIn, as well as work related networks stored in MICROSOFT™ OUTLOOK™ contacts or other data stores. Users may also have other relationships with other users, such as a blogger that has a number of blog followers and commenters. These networks connect the user to other users and give the user a voice that is widely heard among particular communities associated with the user.

Businesses have begun to use such networks for viral marketing. Viral marketing seeks to market a product, service, or idea by placing the marketing content in the hands of influential users that will distribute the content to other users. Unlike traditional marketing that may involve such activities as blasting advertisements on television or to various websites, viral marketing is often much cheaper and more effective at reaching target demographic audiences. For example, getting a popular blogger that covers outdoor topics to cover particular outdoor gear may be more effective at selling the outdoor gear than taking out thousands of dollars' worth of advertisements. Thus, companies are very interested in leveraging users' social networks to distribute information of interest to users in the networks.

Unfortunately, using this medium today is often a hit or miss proposition filled with guesswork. Certain people have positioned themselves as experts in viral marketing, and will act as consultants to design a viral marketing campaign that may or may not ever reach the intended audience. Measuring the success and the path of propagation may also be difficult, but very desirable for the marketer. Marketers want to know which users have been influential in getting information distributed, how information flows between users, and so forth so that future campaigns can be more effectively targeted. Users do not typically want to receive information they are not interested in any more than marketers want to waste effort reaching non-interested users.

### SUMMARY

A social marketing manager may facilitate marketing campaigns in online social networks by creating and monitoring campaigns, as well as facilitating online social interactions. A campaign manager may create a campaign and define various operational parameters. A recruitment system may identify social influencers through which the campaign may be started, and a promotion manager may create and track objects that may be passed to participants in the campaign. An analysis and monitoring system may determine the overall effectiveness of the campaign and provide feedback, payments to participants, or other results of the campaign.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment a social marketing system.

FIG. 2 is a flowchart of an embodiment showing a method for preparing a campaign.

FIG. 3 is a flowchart of an embodiment showing a method for recruiting influencers and distributing campaigns.

FIG. 4 is a flowchart of an embodiment showing a method performed by influencers in interacting with a social marketing system.

FIG. 5 is a diagram of an example embodiment showing a distribution algorithm for a social marketing campaign.

### DETAILED DESCRIPTION

A social media marketing system may provide a single system through which an entire marketing campaign may be created and managed. The marketing system may have several components through which a marketing professional may design a marketing campaign, create or select a compensation plan for the campaign, and select influential people, known as influencers, to join the campaign. The marketing system may also have an interface through which influencers may be made aware of the campaign and elect to participate. The system may further have a system for monitoring and rewarding the various participants.

The social media marketing system may use influential people to drive a marketing campaign through relationships between people. Such a system may be known colloquially as “viral marketing”. In such campaigns, the information for the campaign may be passed between people who have either established relationships or some level of trust or reputation between them. Such campaigns differ from conventional media advertising in that the communications are largely between individual people, rather than from an advertising medium to a targeted person.

The social media marketing may emphasize the trust between people so that a campaign message may be received and believed much more than with conventional advertising campaigns. The trust between people may be created based on an influencer's expertise or reputation in a specific field, as well as through the personal interactions within a person's social network. The campaigns may operate effectively when an influential person may transmit a message to a user, where the user is much less likely to ignore the message and much more likely to believe and act on the message because of the user's explicit or implicit trust in the person.

For the purposes of this specification and claims, the term “person” or “user” may refer to both natural people and other entities that operate as a “person”. A non-natural person may be a corporation, organization, enterprise, team, or other group of people.

For the purposes of this specification and claims, the term “social network” or “online social network” may relate to any type of computerized mechanism through which persons may connect or communicate with each other. Some social networks may be formal systems that facilitate end-to-end communications between people in a social network. Other social networks may be less formal, and may consist of a person's email contact list, phone list, mailing list, or other database from which a person may initiate or receive communication.

In some cases, a social network may facilitate one-way relationships. In such a social network, a first person may establish a relationship with a second person without having the second person's permission or even making the second person aware of the relationship. A simple example may be an informal email contact list where a person may store contact information for other people. Another example may be a social network where a first person “follows” a second person to receive content from the second person or where the person subscribes to a syndicated feed. The second person may or may not be made aware of the relationship.

In some cases, a social network may facilitate two-way relationships. In such a social network, a first person may request a relationship with a second person and the second person may approve or acknowledge the relationship so that the two-way relationship may be established. In some social networks, each relationship within the social network may be a two-way relationship. Some social networks may support both one-way and two-way relationships. Some social networks may also support one-to-many, many-to-many, and many-to-one relationships.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

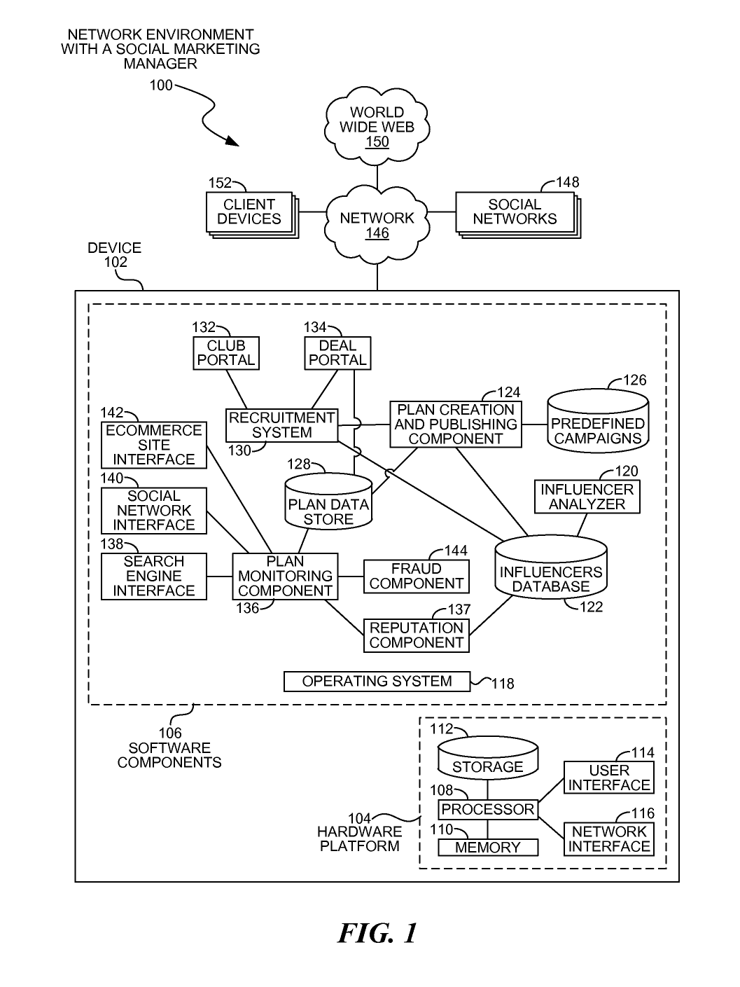

FIG. 1 is a diagram of an embodiment 100, showing an environment in which a social marketing system may operate. Embodiment 100 is a simplified example of a network environment that may include a system by which marketing professionals may create campaigns that may be implemented by a set of social influencers. The social marketing campaigns may be tracked and rewards distributed based on the success of the campaigns.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 may represent a multi-faceted system for managing and operating social marketing campaigns. The social marketing campaigns may operate by sending several influential people a set of campaign materials that include a traceable object. The influential people, known as influencers, may spread the word about the campaign through various social network communications, and the traceable object may be monitored when other people perform some action relating to the campaign, such as purchasing a product, joining a group, making a contribution, or performing some other action. The system may be able to reward the influencers by financial or reputation mechanisms.

The social marketing system of embodiment 100 may operate with two groups of people. A marketing professional may create and manage the campaigns while one or more influencers may actually implement the campaigns. The marketing professional may select a set of influencers and offer an opportunity to the influencers to join the campaign. After the influencers accept the invitation, the influencers may receive various campaign materials, which may include product samples, brochures, reference materials, and in some cases upfront compensation.

The influencers may spread the word about the campaign by contacting other people indirectly or directly. For example, an indirect form of contact may be to publish a weblog posting that relates to the campaign. An example of a direct form of contact may be to email information to people within the influencer's social network.

As part of the campaign, the influencer may transmit a traceable object, which may be a redeemable coupon, link to a website, or other item. The traceable object may be received by a user. In many campaigns, the user may perform some function, such as purchasing a product or performing some other action.

The types of campaigns may be any type of campaign that may have a call to action. In a retail marketing example, the campaign may entice people to purchase a specific item or to visit a specific retail outlet. In a non-profit giving campaign example, users may be enticed to donate money, items, or time to a specific organization. In a political campaign example, users may be called to become active on behalf of a candidate or political cause, such as by donating money, attending a rally, joining a movement, or some other action.

The influencers may be identified by analyzing one or more social networks as well as the person's activities on the World Wide Web. The influencers may be identified by many different manners, including crawling the World Wide Web and various social networks to automatically analyze the person's activities. In some embodiments, the influencers may be manually identified and added to an influencer database.

For example, a person who writes articles for weblogs or other publications, or a person who comments or participates in online discussions may be considered to have expertise in certain categories or contexts. Various metrics may include the number of publications on the topic, the frequency of publication, the frequency of publication compared to other people in the same or different categories, or other metrics.

Other metrics may include the importance or influence of the person's publications. The metrics may include how many times the person's works are referenced, how many subscribers may receive the person's works, the number of page views for the person's works, feedback or comments regarding the person's works, or other types of metrics.

The person's publications may be publically available publications, such as weblog postings, comments, or participation in public forums. In some embodiments, the person's publications may be private or semi-private publications, such as email messages, instant messenger messages, message transmitted within the confines of a social network, or other such messages.

In some embodiments, a person may authorize or permit access for an evaluation system to determine the person's influence or reputation. In such embodiments, a person may sign up for an evaluation of the person's relative expertise in various categories, and the system may provide credentials, offers, or other items in exchange as an enticement for the analysis.

In systems that may access information that may be considered private to the person, the person may have to expressly authorize the system to access such information. Without such access, the system may be limited to analyzing publically available information to determine a person's reputation.

A person may also have influence through their social network activities. A person who is actively involved in social networking may have more influence than people who are not involved.

Various metrics from a social network may imply a person's reputation or influence. The sheer number of relationships may be a factor, and some embodiments may analyze the type or nature of the relationships. Such embodiments may identify relationships between experts in a field as an indicator that the person may also be an expert. Such embodiments may, for example, analyze the frequency that two people interact as an indicator of the strength of the relationship. In some embodiments, two people may enjoy multiple relationships through multiple channels. In such embodiments, the duplicative nature of the relationships may indicate a strong relationship.

For many applications, the actual propagation of a person's content or opinion through a chain of people may be a strong indicator of a person's influence. An example may be a success rate or conversion rate of a person's offers to other people, such as when the person offered a discount coupon or recommended a website, game, or other item to people in their social network. The conversion rate may strongly correlate to the person's influence.

In some instances, a person's comments or publications may start or may be part of a larger conversation across multiple weblogs, chat rooms, social networks, or other methods of communication. In such a case, the person's comments may be tracked or analyzed to determine what influence, if any, the person's comments had in the overall conversation. A person who produces commentary on a topic early and frequently in a long conversation may be considered to have a higher reputation and influence that someone who comments later in the conversation.

In many cases, a person's influence with respect to the campaign system may be raised or lowered based on the person's success or failure with previous campaigns.

Various campaigns may be defined that have different rewards or enticements for the influencers to participate. In some embodiments, the influencers may be rewarded financially based on a formula or algorithm. One example of such an algorithm may be found in embodiment 500 presented later in this specification. The financial rewards may distribute a commission or other financial compensation in a manner that may entice the influencer to participate in the campaign and promote the purpose of the campaign.

In some embodiments, a campaign may provide reputation incentives for the influencers. For example, an influencer may be given a badge or other reputation indicator to show how influential or important the influencer may be within a certain sphere or topic. The badge or reputation indicator may be a credential that the influencer adds to a webpage or social network, for example. Some embodiments may include both financial and reputation incentives.

The campaign management system may include mechanisms for monitoring the operations of the campaign. The monitoring portion may identify actions that may be taken with the traceable object, such as when the traceable object is passed from one person to another, or when the traceable object is used to perform the desired action of the campaign, such as purchasing a product or joining a political cause, for example.

In some cases, the traceable object may be a coupon that may offer a discount or other financial opportunity to purchase a particular product. For each influencer, a specific coupon may be created that contains may be traceable back to the influencer. After an influencer accepts the terms of the campaign, a traceable coupon may be created for the influencer and added to a database containing information about the campaign.

The monitoring system may be able to monitor activity with the traceable object through a website, ecommerce site, retail establishment, or other monitoring point. When the monitoring system detects the traceable object, the campaign database may be updated with the activity.

The monitoring system may issue rewards or compensation to the influencers based on the campaign definition. In some embodiments, the rewards may be issued as they are accumulated while in other embodiments, the rewards may be issued periodically or when the campaign has been closed.

The system of embodiment 100 is illustrated as being contained in a single device. In many embodiments, various software components may be implemented on many different devices. In some cases, a single software component may be implemented on a cluster of computers. Some embodiments may operate using cloud computing technologies for one or more of the components.

The system of embodiment 100 may be accessed by various client devices 152. The client devices 152 may access the system through a web browser or other application. In some embodiments, certain persons may access the system in a different manner. For example, a marketing professional may have a dedicated application through which the campaigns may be created and managed, while an influencer may use a web browser to perform some or all of the influencer tasks.

The device 102 may have a set of hardware components 104 and software components 106. The client device 102 may represent any type of device that may communicate with a live system 126.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. The network interfaces 116 may include hardwired and wireless interfaces through which the device 102 may communicate with other devices.

The software components 106 may include an operating system 118 on which various applications may execute.

An influence analyzer 120 may identify and rank influencers in various categories and store the influencer information in the influencer database 122. In some embodiments, the influence analyzer 120 may crawl the World Wide Web 150 and various social networks 148 to identify people who exhibit influential properties. In some cases, the influencers may be people who have demonstrated expertise or knowledge in certain fields. In some cases, the influencers may be people who are actively involved in their social networks and have implied or demonstrated influence or reputation within their social networks.

The plan creation and publishing component 124 may provide one or more interfaces through which distributors and marketers interact with the system to view social incentives and manage marketing plans. The plan creation and publishing component 124 may provide a desktop application, web application, mobile application, programmatic application programming interface (API), web service, or other interface through which users can access the system. Marketing professionals may access the system to create a new marketing campaign or monitor existing marketing campaigns (either historical or in-progress).

The plan creation and publishing component 124 may receive information from a marketer for creating a marketing plan that includes a distribution schedule for allotting social incentives to distributors that participate in marketing a product associated with the marketing plan. The term “product” may include products, services, information, content, or other items distributed by marketers. The plan may include information such as how many levels to which incentives will propagate, a magnitude of incentive at each level, referral incentives that propagate along the path of distribution, fraud detection methods, and other information that comprises a marketing plan.

The system of embodiment 100 may also offer one or more predefined marketing plans that the marketer can select and/or modify to create a marketing plan for the marketer's particular product. Such marketing plans may be stored in a set of predefined campaigns 126. A marketing professional may be able to browse the available campaigns and either use the campaign as defined or customize an existing campaign.

The plan data store 128 may store information about created marketing plans and receives requests from other components to carry out the plan. The plan data store 128 may include one or more in-memory data structures, files, file systems, hard drives, databases, storage area networks, cloud-based storage services, or other facilities for persisting data. The plan creation and publishing component 124 may store created plans in the plan data store 128, and the other components (e.g., the plan monitoring component 136) access the plan data store 128 to load plan information to carry out the plan. For example, as distributors perform desired activities the plan monitoring component 136 may access the plan data store 128 to determine an incentive to provide to a distributor.

The recruitment system 130 may distributes marketing content to one or more distributors in accordance with the received marketing plan. For example, the marketing plan may specify that the marketing content will be initially sent to one or more heavy influencing distributors. A distributor may be considered heavy influencing based on past success rate at getting other users to download or view content, past earned incentives, reputation defined in the influencer database 122, and so on. The marketer may also manually specify one or more heavy influencing users to which to seed the marketing campaign. The recruitment system 130 may manage distribution and tracks a route of distribution from one distributor to another so that any incentives specified by the plan can be assessed and provided to the appropriate users.

The recruitment system 130 may be implemented in a club portal 132 and a deal portal 134. The club portal 132 may be a website, social network, or other forum in which influencers may view various campaigns. In some embodiments, the influencers may register with the club portal to gain access while other embodiments may be open to all.

Some campaigns may be open campaigns where any influencer may be able to participate. Other embodiments may have invitation-only campaigns where a marketing professional may select the specific influencers for an offer. The influencer may register with the system, if not already registered, and use the deal portal 134 to accept and manage individual campaigns.

The deal portal 134 may be a user interface through which an influencer may engage with a campaign. The influencer may be able to download or retrieve information relating to the campaign, monitor the status of the campaign, determine whether the influencer has received any benefit from the campaign, or other operations.

The plan monitoring component 136 may monitor marketing plans that are in progress of being distributed to users. The monitoring may include tracking which users have distributed the marketing content, how many users have seen the marketing content, which users have earned particular incentives, how many marketing dollars have been spent, how much of a product has been purchased, and so forth. The plan monitoring component 136 may gather data about marketing plans from a search engine interface 138, a social network interface 140, and an ecommerce site interface 142.

The search engine interface 138 may gather information about searches being performed for the same topic as the campaign. The searches may identify activity relating to the traceable objects or may merely identify activity by people who transmit or receive the traceable objects.

The social network interface 140 may be able to monitor or search various social networks to detect any activity with the traceable objects. Similarly, an ecommerce site interface 142 may detect activity, such as coupon redemption, that may be performed with a traceable object.

The plan monitoring component 136 may generate information used by a reputation component 137.

The reputation component 137 may capture and publish information related to influencer reputation. The information may include number of distributions or invitations to view content, number of acceptances of attempts to distribute, conversion rates of referred users, and so on. Reputation information may also include negative reputation factors, such as attempts at fraud or other detected suspicious activity. The reputation component 137 may gather reputation information and publish the information so that other users, such as marketers or other distributors, can view a particular influencer's reputation to determine whether they want to work with the influencer or make other decisions. The reputation component 137 may create a summary of all of the captured reputation information, such as a numeric score, to quantify a person's reputation.

The fraud detection component 144 may detect fraudulent activity related to marketing plans. Fraudulent activity may include falsifying invitations so that it appears that an influencer has more widely distributed marketing content than is in fact true, using false email addresses, impersonating other users, complaints of spam by the user, or any other activity that is contrary to the purpose of the social marketing system. The fraud detection component 144 may take remediation actions such as banning a user, reducing the user's reputation score, limiting how many user's a distributor can send invitations to per period, limiting which user's a distributor can send invitations to (e.g., only friends), and so forth.

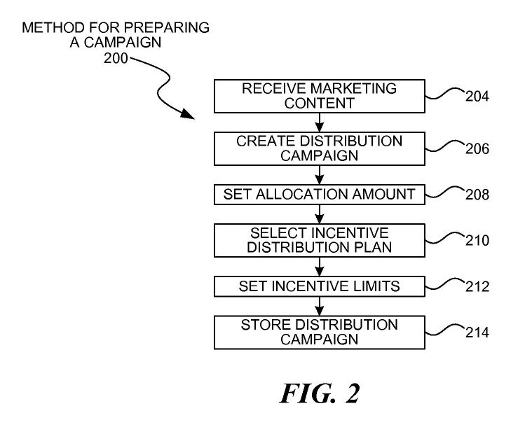

FIG. 2 is a flowchart illustration of an embodiment 200 showing a method for preparing a campaign. Embodiment 200 is a simplified example of a method that may be performed by a plan creation and publishing component with the interaction of a marketing professional, such as the operations that may be performed by the plan creation and publishing component 124 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Beginning in block 204, the system receives marketing content to be distributed by one or more distributors in a marketing campaign. For example, the marketing content may be an application registered in an application marketplace (e.g., a mobile phone online store), a physical product purchased in a store by a user of the system, a movie to be downloaded through a video on demand system, or other content. The system may receive the content through a web page for creating marketing campaigns, through a plug-in to an existing social network (e.g., Facebook), via email from a marketer, or through other methods.

Continuing in block 206, the system creates a distribution campaign in response to a request by a marketer associated with the received marketing content. The distribution campaign associates all of the information related to the marketing content in one place, such as incentive distribution schemes, marketing dollars allocated to distributing the content, channels for distributing the content, any time limits on the marketing campaign, and so forth.

Continuing in block 208, the system sets an allocation amount that indicates how much the marketer will spend on the created distribution campaign. The allocation amount may be specified in a currency (e.g., dollars), as a percentage of a quantity (e.g., 5% of sales), in non-monetary quantities (e.g., using incentive points from the marketer acting as a distributor for other content), and so forth. The system may receive the allocation amount from the marketer or automatically determine an amount based on defaults. Non-monetary incentives may also include virtual goods, such as badges and reputation credits. In the case of online gaming, virtual goods can be new powers or accessories for the user's virtual character.

Continuing in block 210, the system selects an incentive distribution plan that indicates one or more incentives to be given to distributors of the marketing content. The incentive plan may include hierarchical layers that establish a chain of distribution and incentives. For example, if a first user buys a product and recommends that product to a second user, then the first user may receive one point for the recommendation. If the second user recommends the product to a third user, then the second user may receive a point, and the first user may receive a point or a fraction of a point for the second user's recommendation. The first user's initial recommendation to the second user led to the third user being recommended the content, so the first user is rewarded by the incentive. In this way, those users that are very effective and serve as conduits to a large number of other users will receive high points and incentives that reward them for the influence and ability to distribute content effectively. The marketer may select the incentive distribution plan from a set of predetermined options or may create a custom incentive distribution plan tailored to the marketer's goals.

Continuing in block 212, the system sets any incentive limits. For example, the system may receive limits from the marketer that determine how many levels deep in a chain of distributors a marketing incentive will be awarded, how many marketing dollars can be spent, how many invitations a single user can send, how much incentive value a single distributor can receive, or any other limits provided by the system and selected by the marketer.

Continuing in block 214, the system stores the distribution campaign and incentive distribution plan in a data store and starts the campaign. The system may store all of the information gathered in the previous steps in a data store, such as a database, that is accessed by components of the system throughout the duration of the marketing campaign to enforce and carry out the scope selected for the marketing campaign. After block 270, these steps conclude.

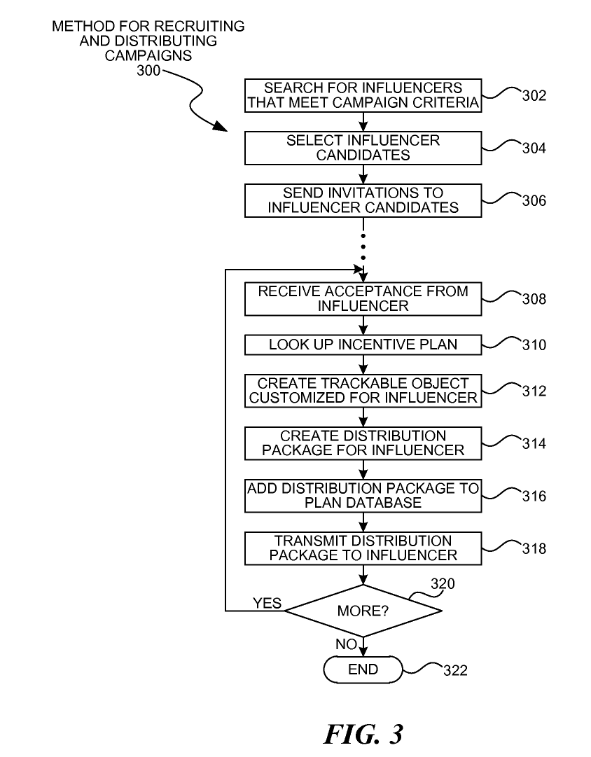

FIG. 3 is a flowchart illustration of an embodiment 300 showing a method for recruiting and distributing campaigns. Embodiment 300 is a simplified example of a method that may be performed by a recruitment system, such as the operations that may be performed by the recruitment system 130 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a method by which influencers may be recruited and supplied with information about a campaign.

In block 302, a search may be performed for influencers that meet certain criteria for the campaign. In some embodiments, the search may be performed on an influencer database. In other embodiments, the search may be performed by searching the World Wide Web, social networks, or other locations.

Various influencer candidates may be selected in block 304. The influencers may be selected based on prior history, knowledge or specialty in the field of the campaign, personal experience by the marketing professional, general reputation, or any other criteria.

The selected influencers may be sent invitations to join the campaign in block 306. In some embodiments, the influencers may be contacted individually, such as with an email invitation. In other embodiments, the campaign may be listed on a portal or website from which the influencers may browse various campaigns and select one in which to participate.

In block 308, acceptance may be received from an influencer. Each campaign may have different acceptance criteria. In some cases, the influencer may agree to perform certain tasks, purchase a sample product, or perform other actions as a condition for acceptance. In other cases, the influencer may merely agree to participate with no obligation.

The incentive plan may be looked up in block 310 and a traceable object may be created that is customized for the influencer in block 312.

A distribution package may be created for the influencer in block 314. The distribution package may include information about the campaign, such as campaign literature, product samples, access to insider information about the campaign, or other information. The distribution package may also include the customized traceable object from block 312.

The distribution package may be added to the plan database in block 316 so that the traceable object may be monitored and rewards distributed when the conditions of the campaign are met.

The distribution package may be transmitted to the influencer in block 318. If more influencers accept the invitation in block 320, the process may return to block 308, otherwise the process may end in block 322.

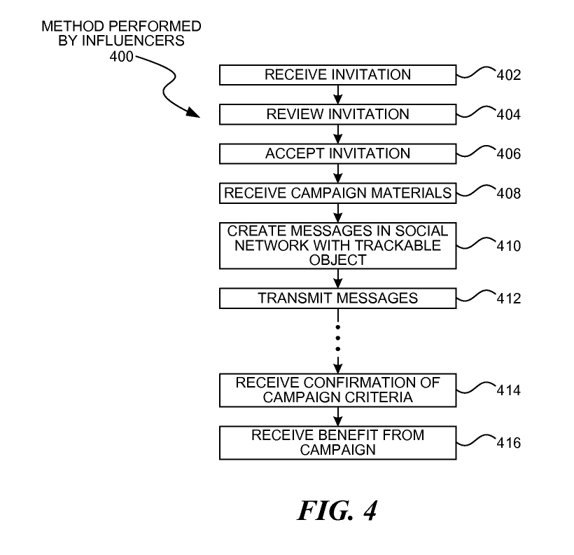

FIG. 4 is a flowchart illustration of an embodiment 400 showing a method for influencers. Embodiment 400 is a simplified example of a method that may be performed by an influencer as the influencer interacts with a recruitment system, such as the recruitment system 130 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 402, the influencer may receive an invitation to a campaign. The influencer may review the invitation in block 404 and may accept the invitation in block 406. The campaign materials may be sent to the influencer in block 408.

After receiving the campaign materials, the influencer may begin spreading the word about the campaign. Each influencer may have a different social network or different mechanisms by which the influencer transmits information about the campaign. Some influencers may write about the campaign in a weblog, post messages in a formal social network, send email messages or make telephone calls in an informal social network, or get the word out in some other manner. The messages may be transmitted in block 412.

Over time, the influencer's messages may be passed from one person to another and may be acted upon by some people. When those people perform an action, such as redeeming a coupon, signing up for a service, visiting an ecommerce site, or other action, the campaign monitoring system may detect the activity and update the influencer's campaign.

The influencer may receive confirmation of various campaign activities by the system in block 414 and may receive a benefit in block 416. In some cases, the benefit may be a financial compensation. Some campaigns may provide updated influence factors, reputation, or other awards based on the success or failure of the influencer in the campaign.

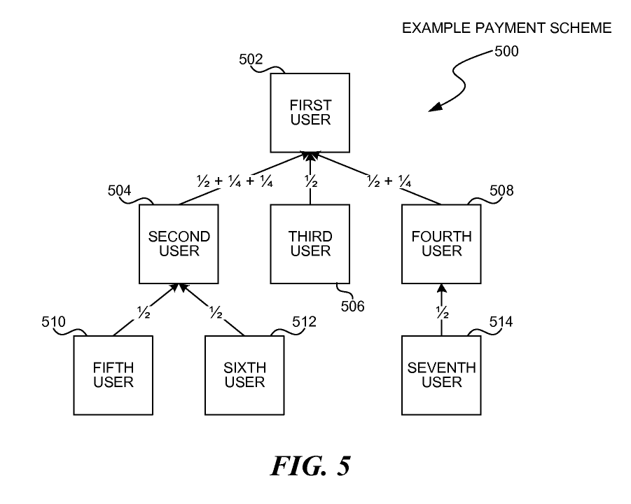

FIG. 5 is a block diagram that illustrates a weighted distribution of incentives using the social incentive system, in one embodiment. FIG. 5 illustrates merely one example of a distribution system by which an influencer may receive financial benefit from a campaign in a multilevel marketing example.

A first user 502 has a social network of many friends. Of these friends, three friends (second user 504, third user 506, and fourth user 508) completed steps specified in a marketing plan for the first user 502 to receive an incentive. Because of each of the three friends' actions, the first user 502 receives a ½ point weighted incentive from each user. Moreover, second user 504 refers content associated with the marketing plan to a firth user 510 and sixth user 512 who each completed steps specified in the marketing plan for the second user 504 to receive an incentive. Therefore, second user 504 also receives a ½ point weighted incentive from each user. I

In addition, this particular marketing plan allows incentives to propagate along the distribution chain at a decaying value, so first user 502 receives a ¼ point weighted incentive because of fifth user 510 and sixth user 512's actions. Likewise, fourth user 508 refers the content to seventh user 514, so fourth user 508 receives a ½ point weighted incentive, and first user 502 receives an additional ¼ point weighted incentive. As illustrated, distributors' actions to distribute content create a tree of incentives, and the marketing plan configured by the marketer determines an amount and type of incentive received at each level, as well as how incentives propagate through the tree. If a user is very influential, such as first user 502, the incentives can quickly add up to significant rewards, thus encouraging the user to further work to distribute the content.

Consumers in general are great at promoting products. A father buying his daughter a bicycle may recommend the bicycle to other parents that he knows based on his experience with the product. Similarly, a blogger may review items she has used and post information that causes other users to purchase the items. Two business owners may help each other find business and pay each other a referral fee for each client referred. These types of activities happen today without any formal specification or control of their occurrence. In addition, there is no way for marketers of products to reward users for their positive promotion of a product or request that the users work to further promote the product with their social network. The social incentive system provides a configurable, formalized specification of how users that distribute information about marketable items can receive incentives for doing so. Marketers can tailor incentive plans and spend marketing dollars to encourage more of this type of beneficial activity for selling products.

In some embodiments, the social incentive system contains some online components and some physical components. For example, distributor may purchase a physical product (e.g., a bicycle) in a brick-and-mortar store and receive a coupon or information sheet for promoting the item to the distributor's friends. If the distributor mentions the item to the distributor's friends, then the system may send an electronic or physical coupon that the friend can use to get a discount on the product. A user at one level of a distribution chain may receive coupons to give to friends, while distributors at higher levels receive points or other incentives as friends or friends of friends in the chain use the coupons to purchase products. The coupon may allow the system to track who purchased the product because of a particular recommendation (e.g., through a barcode or other information on the coupon captured at the time of sale).

In some embodiments, the social incentive system includes negotiable incentives. While incentives may be fixed by the marketer, the marketer may also allow distributors to negotiate an incentive either with the marketer or with other distributors. For example, a distributor may agree to give part of his incentive share to a friend if that friend agrees to redistribute the content or product to the friend's friends. In this way, the distributor can use his own ingenuity and strategy for encouraging further distribution of the marketable item.

In some embodiments, the social incentive system establishes distribution quotas based on a distributor's reputation to avoid spam. The system may include both hard and soft quotas. A hard quota may enforce that a distributor with a low reputation cannot continue to receive incentives until the distributor raises his reputation (e.g. by accepted referrals). A soft quota may slowly diminish or increase rewards based on a distributor's reputation. A distributor may start with a limited number of recommendations to distribute, and receive more as friends accept the earlier ones. If people are not accepting the distributor's recommendations, indicating potential spam, then this will act as a limit on how many recommendations the distributor can make.

In some embodiments, the social incentive system associates a cost with recommendations to reduce spam. For example, the system may charge a distributor for each recommendation to encourage the distributor to only send recommendations that the distributor believes will be accepted, so that the distributor will get a return that overcomes the cost. The charge can refer to real currency or go against virtual recommendation credits or other virtual currency that the system introduces and maintains. If the distributor chooses to spam his friends with product recommendations, then eventually the cost of the recommendations as no one or few friends accept will discourage the distributor from further spamming behavior.

In some embodiments, the social incentive system punishes distributors for bad or ineffective recommendations. For example, if the distributor sends recommendations that are not accepted, then the system may subtract from successful recommendations, reduce previously awarded incentives, reduce the distributor's reputation, and so forth. The system may allow some error rate threshold (e.g., 10%) of non-acceptances before taking away from the distributor's reputation or incentives.

In some embodiments, the social incentive system receives feedback from recommendation recipients about the recommendation and/or distributor that sent the recommendation. For example, a recipient may indicate that the recipient liked the recommendation even if the recipient is not accepting the invitation or buying the product. In this way, the distributor's reputation or incentives may be increased even though the recipient did not ultimately choose to purchase the product recommended (e.g., perhaps the recipient already had the product or exceeded his budget for discretionary expenses for the month). The recipient may also explicitly indicate that a recommendation is considered spam, causing the system to take negative action against the distributor.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a campaign manager that creates a campaign and stores said campaign in a campaign database, said campaign having a usage context and defining a rewards scheme;
a promotion manager that generates a traceable object being associated with said campaign;
a recruitment system that:
identifies a plurality of influencers, said influencers having an expertise in said usage context and being members of at least one online social network;
creates an influencer package comprising said traceable object and campaign information relating to said usage context; and
communicates with said influencers about said influencer package;
a monitoring system that:
identifies uses of said traceable object within said online social network;
determines a route of passage between users of said online social network for said traceable object; and
implements said reward scheme based on said route of passage and said uses of said traceable object.

2. The system of claim 1, said recruitment system that sends and offer for said influencer package to said influencers and receives acceptance of terms for said reward scheme from said influencers.

3. The system of claim 2, said reward scheme comprising increasing an influencer's influence rating based on participating in said campaign.

4. The system of claim 1, said traceable object comprising a coupon for a consumer.

5. The system of claim 4, each of said influencers having an influencer package comprising a unique traceable object.

6. The system of claim 1, said monitoring system that further:
identifies actions performed by said influencers; and
classifies said actions as at least one of a group composed of positive and negative actions.

7. The system of claim 6, said monitoring system that identifies a first negative action for a first influencer and increases said influence factor for said first influencer.

8. The system of claim 1, said influencer package comprising a product sample.

9. The system of claim 1, said recruitment system that further:
identifies a first group of influencers having high influence and offers a first influencer package to said first group of influencers; and
identifies a second group of influencers having a lower influence than said first group of influencers and offers a second influence package to said second group of influencers.

10. The system of claim 9, said first influencer package having a first reward scheme and said second influencer package having a second reward scheme.

11. The system of claim 1, said monitoring system that further determines rewards for each of said influencers that participate in said campaign.

12. The system of claim 11, said rewards comprising increasing an influence factor for said influencers.

13. A method comprising:
identifying a social marketing campaign and creating a social marketing instance in a campaign database;
for said social marketing campaign, identifying a plurality of influencers, said influencers being people having connections within at least one online social network who have previously performed at least one act of influence within said online social network;
for each of said plurality of influencers, transmitting an offer to participate in said social marketing campaign and receiving a response from a first set of influencers;
for each of said first set of influencers, transmitting an influencer package comprising a traceable object capable of being transmitted within said at least one social network;
monitoring said at least one social network to detect passage of said traceable object within said at least one social network; and
determining a compensation for each of said first set of influencers based on said passage.

14. The method of claim 13, said compensation being an adjustment of influence level for at least some of said first set of influencers.

15. The method of claim 14 further comprising:
detecting that a first influencer created a negative review associated with said campaign; and
increasing said influence level of said first influencer.

16. The method of claim 14 further comprising:
detecting that a first influencer created a positive review associated with said campaign; and
decreasing said influence level of said first influencer.

17. The method of claim 16 further comprising:
determining an expected result for said first influencer and determining an actual result for said first influencer, said first expected result and said actual result comprising a number of said passages.

18. A system comprising:
a campaign manager that creates a campaign and stores said campaign in a campaign database, said campaign having a usage context and defining a rewards scheme, said rewards scheme being selected from a plurality of predefined rewards schemes;
a promotion manager that generates a traceable object being associated with said campaign, said traceable object being associated with said rewards scheme;
a recruitment system that:
identifies a plurality of influencers, said influencers having an expertise in said usage context and being members of at least one online social network;
groups said plurality of influencers into a plurality of groups based on an influence score;
creates a plurality of groups of influencer packages comprising said traceable object and campaign information relating to said usage context, each of said plurality of groups of influencer packages corresponding to said plurality of groups of influencers;
communicates with said influencers about said influencer package;
receives acceptance from a first group of influencers; and
for each of said influencers in said first group of influencers, transmitting one of said influencer packages;
a monitoring system that:
identifies uses of said traceable object within said online social network;
determines a route of passage between users of said online social network for said traceable object; and
implements said reward scheme based on said route of passage and said uses of said traceable object.

19. The system of claim 18, said reward scheme comprising increasing said influence score based on participating in said campaign.

20. The system of claim 19, said monitoring system that further detects at least one action by said influencers relating to said campaign.
